(19) United States
(12) Patent Application Publication
(10) Pub. No.: US 2019/0286036 A1
(43) Pub. Date: Sep. 19, 2019

(54) PRINTING SYSTEM, IMAGE FORMING APPARATUS, AND NON-TRANSITORY RECORDING MEDIUM

(71) Applicant: Youichi MINEGISHI, Kanagawa (JP)

(72) Inventor: Youichi MINEGISHI, Kanagawa (JP)

(73) Assignee: Ricoh Company, Ltd., Tokyo (JP)

(21) Appl. No.: 16/289,768

(22) Filed: Mar. 1, 2019

(30) Foreign Application Priority Data
Mar. 14, 2018 (JP) 2018-047360

(51) Int. Cl. G03G 15/00; G03G 15/01

(52) U.S. Cl. CPC G03G 15/5091; G03G 15/0121

(57) ABSTRACT

A printing system includes a memory, and a processor coupled to the memory and configured to determine whether printing with an invisible toner is possible in an image forming apparatus, and generate, when the printing with the invisible toner is determined to be possible, print data for causing the image forming apparatus to use the invisible toner to perform printing for assurance of authenticity, and generate, when the printing with the invisible toner is determined not to be possible, print data for causing the image forming apparatus to use a toner other than the invisible toner to perform printing for assurance of authenticity.

### CROSS-REFERENCE TO RELATED APPLICATION

The present application claims priority under 35 U.S.C. § 119 to Japanese Patent Application No. 2018-047360, filed on Mar. 14, 2018, the entire contents of which are incorporated herein by reference.

### BACKGROUND OF THE INVENTION

### 1. Field of the Invention

The disclosures herein generally relate to a printing system, an image forming apparatus, and a non-transitory recording medium.

### 2. Description of the Related Art

For example, Patent Document 1 below discloses an image forming apparatus capable of forming a document image by using a visible toner and forming a code image by using an invisible toner. The image forming apparatus provides a technology that detects a failure of supply of the invisible toner, and based on the detected failure of supply of the invisible toner, changes a method for forming a code image to another method (such as a method that reduces the amount of the invisible toner used or a method that does not use the invisible toner).

However, in a case where a code image is formed on a print medium without using the invisible toner and the print medium on which the code image is printed is copied, the same code image is printed on a copy destination medium. Thus, with the technology disclosed in Patent Document 1, the authenticity of the original print medium cannot be assured.

### Related-Art Documents

### Patent Documents

### [Patent Document 1] Japanese Unexamined Patent Application Publication No. 2007-78981

### SUMMARY OF THE INVENTION

According to at least one embodiment, a printing system includes a memory, and a processor coupled to the memory and configured to determine whether printing with an invisible toner is possible in an image forming apparatus, and generate, when the printing with the invisible toner is determined to be possible, print data for causing the image forming apparatus to use the invisible toner to perform printing for assurance of authenticity, and generate, when the printing with the invisible toner is determined not to be possible, print data for causing the image forming apparatus to use a toner other than the invisible toner to perform printing for assurance of authenticity.

### BRIEF DESCRIPTION OF THE DRAWINGS

FIG. 1 is a diagram illustrating a configuration of a printing system according to a first embodiment of the present invention;

FIG. 2 is a diagram illustrating a schematic configuration of a printer according to one embodiment of the present invention;

FIG. 3 is a diagram illustrating a hardware configuration of a PC according to one embodiment of the present invention;

FIG. 4 is a diagram illustrating a functional configuration of the printing system according to the first embodiment of the present invention;

FIG. 5 is a diagram illustrating an example of a UI provided for the PC according to the first embodiment of the present invention;

FIG. 6 is a processing sequence performed by the printing system according to the first embodiment of the present invention;

FIG. 7 is a processing sequence performed by the printing system according to the first embodiment of the present invention;

FIG. 8 is a processing sequence performed by the printing system according to the first embodiment of the present invention;

FIG. 9 is a flowchart illustrating determination logic of an authenticity assurance function of the PC according to the first embodiment of the present invention;

FIG. 10 is a diagram illustrating a functional configuration of a printing system according to a second embodiment of the present invention;

FIG. 11 is a processing sequence performed by the printing system according to the second embodiment of the present invention;

FIG. 12 is a processing sequence performed by the printing system according to the second embodiment of the present invention;

FIG. 13 is a processing sequence performed by the printing system according to the second embodiment of the present invention;

FIG. 14 is a flowchart illustrating determination logic of an authenticity assurance function of a printer according to the second embodiment of the present invention; and

FIG. 15 is a diagram illustrating an example of print setting information transmitted to the printer in the printing system according to the second embodiment.

### DESCRIPTION OF THE PREFERRED EMBODIMENTS

It is a general object of at least one embodiment of the present invention to enable printing for assurance of authenticity regardless of whether an image forming apparatus can use an invisible toner.

In the following, embodiments of the present invention will be described with reference to the accompanying drawings.

### First Embodiment

A first embodiment of the present invention will be described with reference to the accompanying drawings.

### (Configuration of Printing System 10)

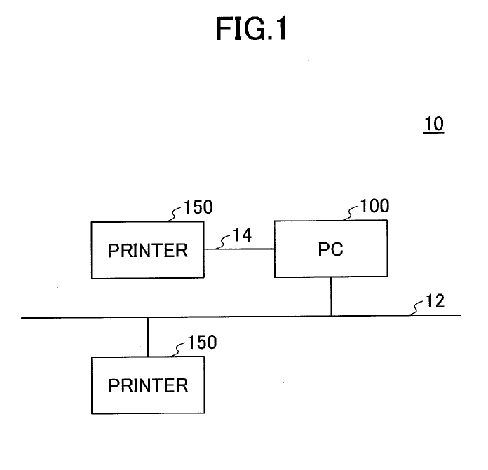

FIG. 1 is a diagram illustrating a configuration of a printing system 10 according to the first embodiment. The printing system 10 illustrated in FIG. 1 includes a personal computer (PC) 100 and a plurality of printers 150. The PC 100 is an example of a “print control apparatus” and controls printing by the printers 150. Each of the printers 150 is an example of an “image forming apparatus” and performs printing on a print medium. Each of the printers 150 is communicatively connected to the PC 100. For example, in the example illustrated in FIG. 1, one printer 150 is directly connected to the PC 100 through a communication cable 14. Examples of the communication cable 14 include a universal serial bus (USB) cable. Also, in the example illustrated in FIG. 1, another printer 150 is connected to the PC 100 through a network 12. Examples of the network 12 include an internal local area network (LAN) and a virtual private network (VPN). The PC may be connected to the network 12 through wireless communication or through wired communication. Note that the “print control apparatus” is not limited to the PC, and may be any apparatus such as a tablet terminal and a smartphone. Also, the “print control apparatus” may be included in each of the printers 150.

In the first embodiment, a color printer that has four toners including a yellow (Y) toner 162Y, a cyan (C) toner 162C, a magenta (M) toner 162M, and a black (K) toner 162K is used as each of the printers 150. Also, in the first embodiment, instead of the K toner, an invisible toner (an example of a “transparent toner”) is installed in each of the printers 150. The invisible toner is a toner that is difficult to be visually recognized, but can be recognized by a dedicated apparatus.

### (Configuration of Printer 150)

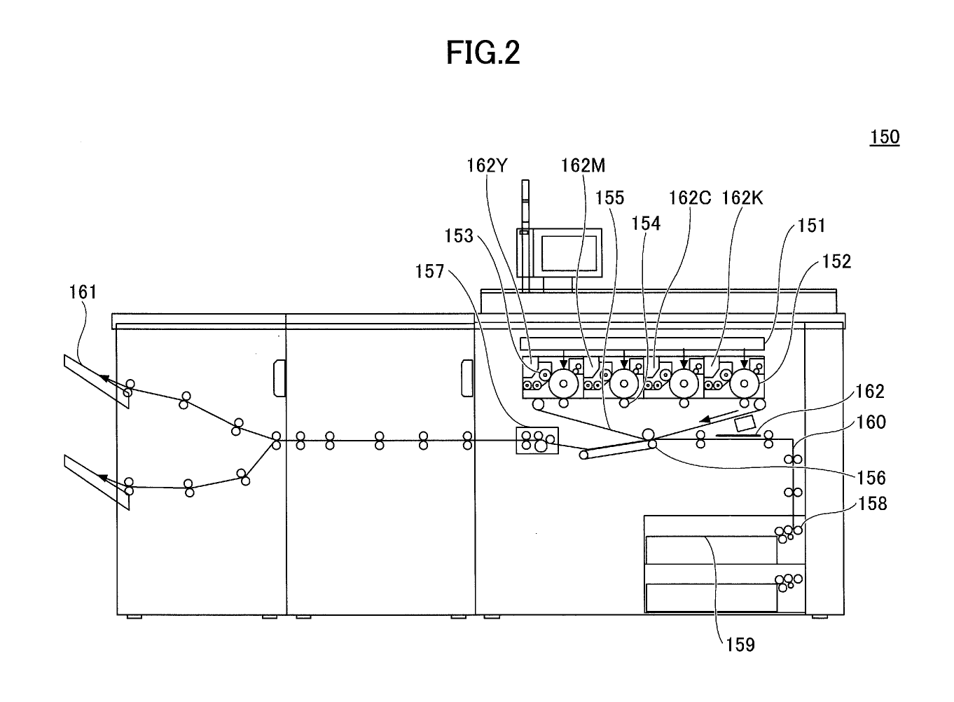

FIG. 2 is a diagram illustrating a schematic configuration of a printer 150 according to one embodiment of the present invention. As illustrated in FIG. 2, the printer 150 includes an optical device 151, a photoconductor drum 152, a developing roller 153, a transfer roller 154, a transfer belt 155, a transfer roller 156, a fixing device 157, a conveyance device 158, a paper tray 159, a conveyance path 160, a paper-discharging tray 161, and recording paper 162.

The optical device 151 uses, for example, a laser diode as a laser source. The optical device 151 irradiates the uniformly-charged photoconductor drum 152 with laser light, in accordance with print data that is input externally (for example, from the PC 100).

By irradiating the surface of the uniformly-charged photoconductor drum 152 with the laser light in accordance with the print data, electric charge disappears only from the surface irradiated with the laser light. As a result, a latent image is formed on the surface of the photoconductor drum 152 in accordance with the print data. The formed latent image is moved in a direction of a corresponding developing roller 153 along with the rotation of the photoconductor drum 152.

The developing roller 153 rotates so as to cause a toner supplied from a toner cartridge to adhere to the surface of the developing roller 153. Then, the developing roller 153 causes the toner adhering to the surface of the developing roller 153 to adhere to the latent image formed on the surface of the photoconductor drum 152. Accordingly, the developing roller 153 develops the latent image formed on the photoconductor drum 152 and forms a toner image on the surface of the photoconductor drum 152.

The toner image formed on the surface of the photoconductor drum 152 is transferred onto the transfer belt 155 between the photoconductor drum 152 and the transfer roller 154. Accordingly, the toner image is formed on the transfer belt 155.

In the printer 150 according to the present embodiment, the optical device 151, the photoconductor drum 152, the developing roller 153, and the transfer roller 154 are provided for each of the four toners (the Y toner 162Y, the C toner 162C, the, M toner 162M, and the K toner 162K). Thus, the printer 150 according to the present embodiment allows a toner image of the four printing colors (Y, C, M, and K) to be formed on the transfer belt 155.

The conveyance device 158 conveys the recording paper 162 from the paper tray 159 to the conveyance path 160. The recording paper 162 conveyed to the conveyance path 160 is supplied between the transfer belt 155 and the transfer roller 156. The toner image of the four printing colors formed on the transfer belt 155 is transferred onto the recording paper 162 between the transfer belt 155 and the transfer roller 156. Next, the fixing device 157 applies heat and pressure to the recording paper 162 such that the toner image is fixed. Next, the recording paper 162 is conveyed to the paper-discharging tray 161.

### (Hardware Configuration of PC 100)

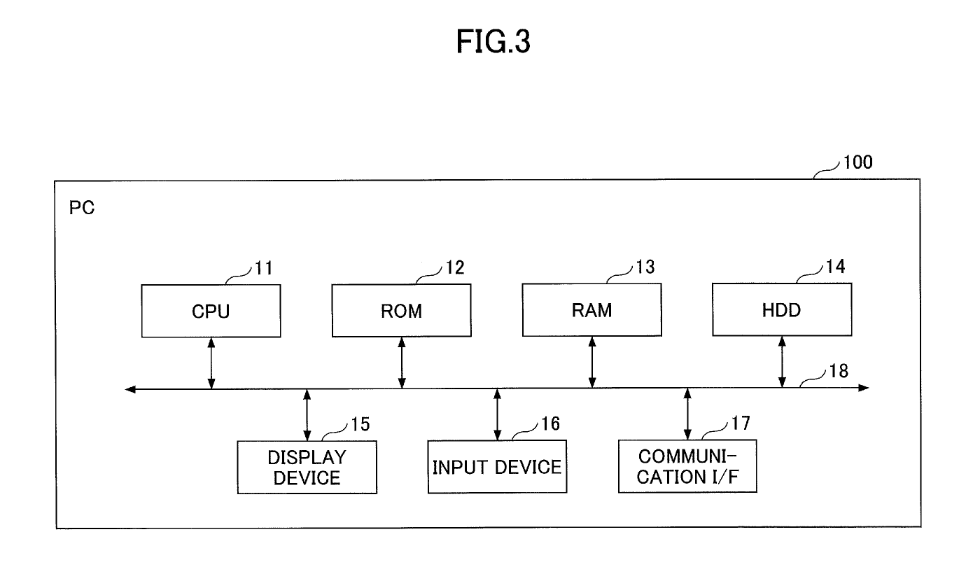

FIG. 3 is a diagram illustrating a hardware configuration of the PC 100 according to one embodiment of the present invention. As illustrated in FIG. 3, the PC 100 includes a central processing unit (CPU) 11, read-only memory (ROM) 12, random-access memory (RAM) 13, and a hard disk drive (HDD) 14, a display device 15, an input device 16, and a communication interface (I/F) 17. The hardware devices are connected to each other via a bus 18.

The CPU 11 executes various types of programs stored in the ROM 12 or in the HDD 14. The ROM 12 is a non-volatile memory. For example, the ROM 12 stores various types of programs executed by the CPU 11 and also stores data necessary for the CPU 11 to execute the various types of programs. The RAM 13 is a main storage device such as dynamic random-access memory (DRAM) and static random-access memory (SRAM). For example, the RAM 13 functions as a working area that is used by the CPU 11 to execute the various types of programs.

The HDD 14 is a non-volatile storage device. For example, the HDD 14 stores various types of programs executed by the CPU 11 and also stores data necessary for the CPU 11 to execute the various types of programs.

The display device 15 displays various types of information. Examples of the display device 15 include a liquid crystal display and an organic electroluminescence (EL) display. The input device 16 is operated by a user to input various types of information. Examples of the input device 16 include a keyboard and a mouse. The communication I/F 17 is an interface for communicating with an external device (such as the printer 150) through the communication cable 14, the network 12, and the like.

### (Functional Configuration of Printing System 10)

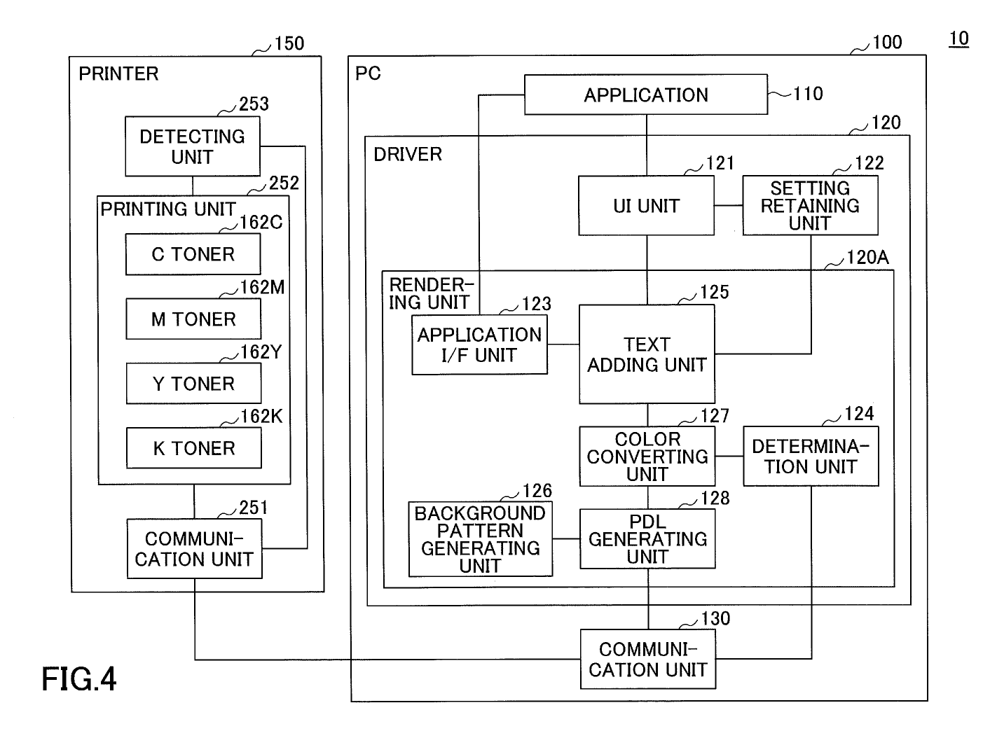

FIG. 4 is a diagram illustrating a functional configuration of the printing system 10 according to the first embodiment of the present invention.

### <Functional Configuration of PC 100>

As illustrated in FIG. 4, the PC 100 includes an application 110, a driver 120, and a communication unit 130. The driver 120 includes a user interface (UI) unit 121, a setting retaining unit 122, and a rendering unit 120A. The rendering unit 120A includes an application I/F unit 123, a determination unit 124, a text adding unit 125, a background pattern generating unit 126, a color converting unit 127, and a PDL (page description language) generating unit 128.

The UI unit 121 provides, with a user, a UI for making print settings. The setting retaining unit 122 retains the print settings made by the user on the UI provided by the UI unit 121. The application I/F unit 123 receives print data of a document image from the application 110. The application 110 according to the present embodiment may be any application having a printing function.

The determination unit 124 determines whether printing with the invisible toner can be performed in the printer 150, based on types of toners detected by a detecting unit 253 of the printer 150 (namely based on detection result data received by the communication unit 130). For example, when the detecting unit 253 detects that the invisible toner is installed in the printer 150 in place of any one of the C toner, the M toner, the Y toner, and the K toner, the determination unit 124 determines that printing with the invisible toner is possible. Conversely, when the detecting unit 253 detects that the invisible toner is not installed in the printer 150 in place of any one of the C toner, the M toner, the Y toner, and the K toner, the determination unit 124 determines that printing with the invisible toner is not possible.

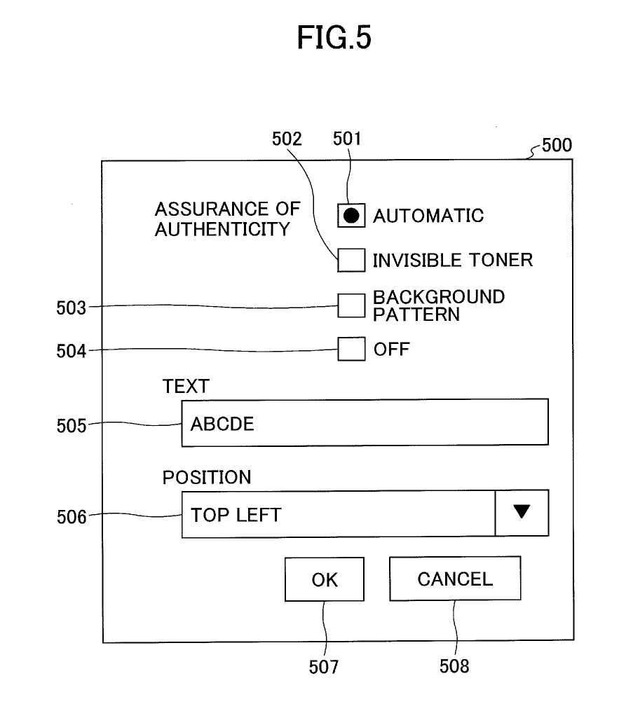

When a setting that causes the printer 150 to use the invisible toner to perform printing for assurance of authenticity is made in the above print settings (for example, when “invisible toner” is selected on a UI screen 500 illustrated in FIG. 5), it is determined that printing with the invisible toner is possible in the printer 150. Conversely, when a setting that causes the printer 150 to use the invisible toner to perform printing for assurance of authenticity is not made (for example, when “background pattern” is selected on the UI screen 500 illustrated in FIG. 5), it is determined that printing with the invisible toner is not possible in the printer 150.

The text adding unit 125 obtains text to be added for assurance of authenticity from the print settings retained by the setting retaining unit 122, and adds the text to the print data of the document image received by the application I/F unit 123 from the application 110.

When the determination unit 124 determines that printing with the invisible toner is not possible, the background pattern generating unit 126 generates a background pattern of the text added by the text adding unit 125.

The color converting unit 127 converts the print data of the document image, to which the text for assurance of authenticity has been added, into print data on a per-toner basis.

For example, when the determination unit 124 determines that printing with the invisible toner is possible, the color converting unit 127 converts the print data of the document image into pieces of print data that use the C toner, the M toner, and the Y toner, and also converts the print data of the text into print data that uses the invisible toner.

For example, when the determination unit 124 determines that printing with the invisible toner is not possible, the color converting unit 127 converts the print data of the document image into pieces of print data that use the C toner, the M toner, the Y toner, and the K toner. Also, the color converting unit 127 replaces the print data of the text with print data of the background pattern of the text generated by the background pattern generating unit 126, and converts the print data of the background pattern of the text into print data that uses the K toner.

The PDL generating unit 128 converts the pieces of print data converted by the color converting unit 127 (namely the print data on a per-toner basis) into pieces of print data in a PDL (page description language) command format.

The communication unit 130 transmits/receives various types of data to/from the printer 150. For example, the communication unit 130 transmits, to the printer 150, the pieces of print data in the PDL command format generated by the PDL generating unit. Also, the communication unit 130 receives, from the printer 150, detection result data indicating a detection result obtained by the detecting unit 253.

The above-described functions of the PC 100 are implemented by, for example, causing the CPU 11 (a computer) to execute a program stored in the ROM 12 or in the HDD 14 within the PC 100. The program may be provided by being preliminarily installed in the PC 100. Alternatively, the program may be externally provided and installed in the PC 100. In the latter case, the program may be provided via an external storage medium (such as USB memory, a memory card, or a CD-ROM) or may be downloaded from a server on a network (such as the Internet).

### <Functional Configuration of Printer 150>

As illustrated in FIG. 4, the printer 150 includes a communication unit 251, a printing unit 252, and a detecting unit 253.

The communication unit 251 transmits/receives various types of data to/from the PC 100. For example, the communication unit 251 transmits, to the PC 100, detection result data indicating a detection result obtained by the detecting unit 253. Also, the communication unit 251 receives print data transmitted from the PC 100.

The printing unit 252 prints various images on a print medium based on print data received from the communication unit 251. To be more specific, when the invisible toner is installed in the printing unit 252, the printing unit 252 uses the C toner, the M toner, and the Y toner to print a document image, which has been output from the application 110, on a print medium, and further uses the invisible toner to print text for assurance of authenticity on the print medium. Conversely, when the invisible toner is not installed in the printing unit 252, the printing unit 252 uses the C toner, the M toner, the Y toner, and the K toner to print a document image, which has been output from the application 110, on a print medium, and further uses the K toner to print a background pattern for assurance of authenticity on the print medium.

The detecting unit 253 detects types of toners installed in the printing unit 252. For example, the detecting unit 253 detects that the C toner, the M toner, the Y toner, and the K toner are installed. Namely, in this case, the detecting unit 253 detects that the invisible toner is not installed. Also, for example, the detecting unit 253 detects that the C toner, the M toner, the Y toner, and the invisible toner are installed. Namely, in this case, the detecting unit 253 detects that the invisible toner is installed in place of the K toner. For example, the detecting unit 253 detects types of toners by obtaining, from each of the toners installed in the printing unit 252, identification information capable of identifying types of toners.

### (Example of UI)

FIG. 5 is a diagram illustrating an example of a UI provided for the PC 100 according to the first embodiment of the present invention. The UI screen 500 illustrated in FIG. 5 is a setting screen that is controlled by the UI unit 121 and is displayed on the display device 15 of the PC 100. The user can make print settings related to assurance of authenticity on the setting screen. As illustrated in FIG. 5, the UI screen 500 includes an “automatic” checkbox 501, an “invisible toner” checkbox 502, a “background pattern” checkbox 503, an “OFF” checkbox 504, an input field 505, a selection field 506, an “OK” button 507, and a “cancel” button 508.

When the “automatic” checkbox 501 is selected on the UI screen 500, the determination unit 124 automatically determines whether printing with the invisible toner is possible, based on detection result information obtained from the printer 150.

Also, when the “invisible toner” checkbox 502 is selected on the UI screen 500, the determination unit 124 determines that printing with the invisible toner is possible. In this case, the driver 120 (the rendering unit 120A) adds text (text that is input in the input field 505), which is to be printed with the invisible toner for assurance of authenticity, to print data received from the application 110.

Also, when the “background pattern” checkbox 503 is selected on the UI screen 500, the determination unit 124 determines that printing with the invisible toner is not possible. In this case, the driver 120 (the rendering unit 120A) adds a background pattern of text (text that is input in the input field 505), which is to be printed for assurance of authenticity, to print data received from the application 110.

Also, when the “OFF” checkbox 504 is selected on the UI screen 500, the driver 120 (the rendering unit 120A) does not add text for assurance of authenticity to print data received from the application 110.

The input field 505 is a field in which to input any text to be added for assurance of authenticity.

The selection field 506 is a field from which to select any printing position of a plurality of preset printing positions of text to be added for assurance of authenticity.

When the “OK” button 507 is selected, print settings made on the UI screen 500 are enabled and the print settings are retained by the setting retaining unit 122. When the “cancel” button 508 is selected, the print settings made on the UI screen 500 are canceled.

### (Processing Sequence Performed by Printing System 10)

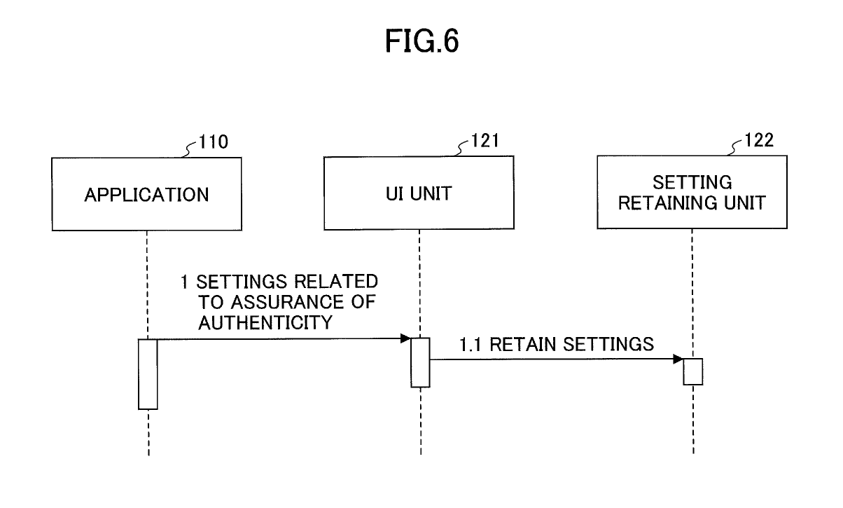

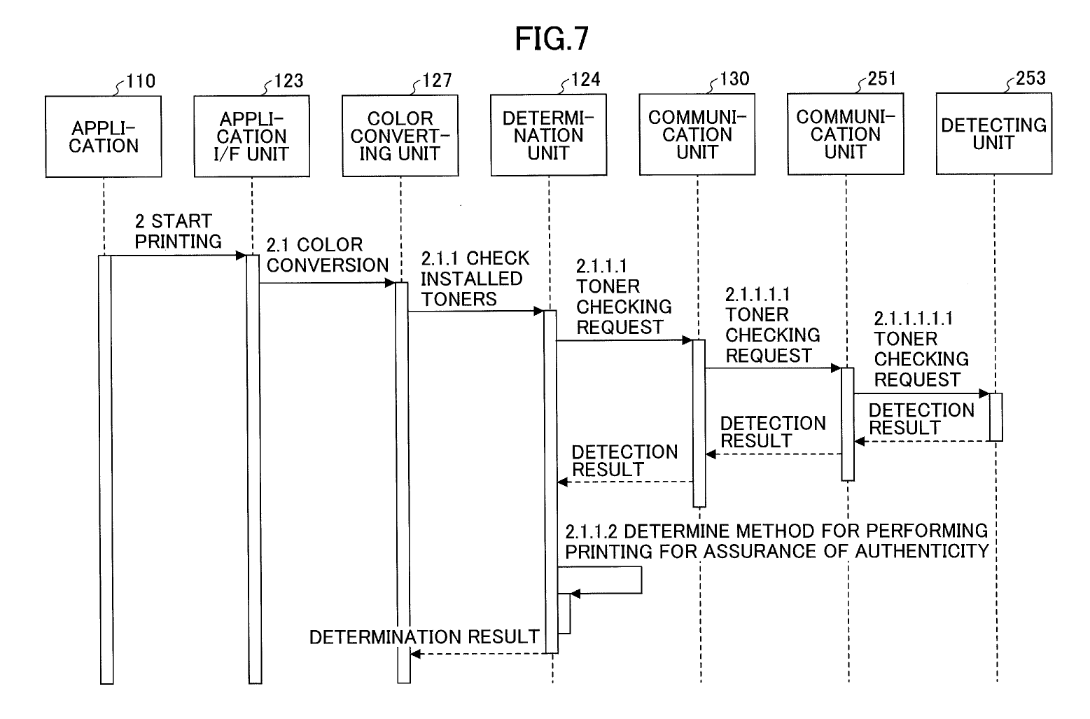

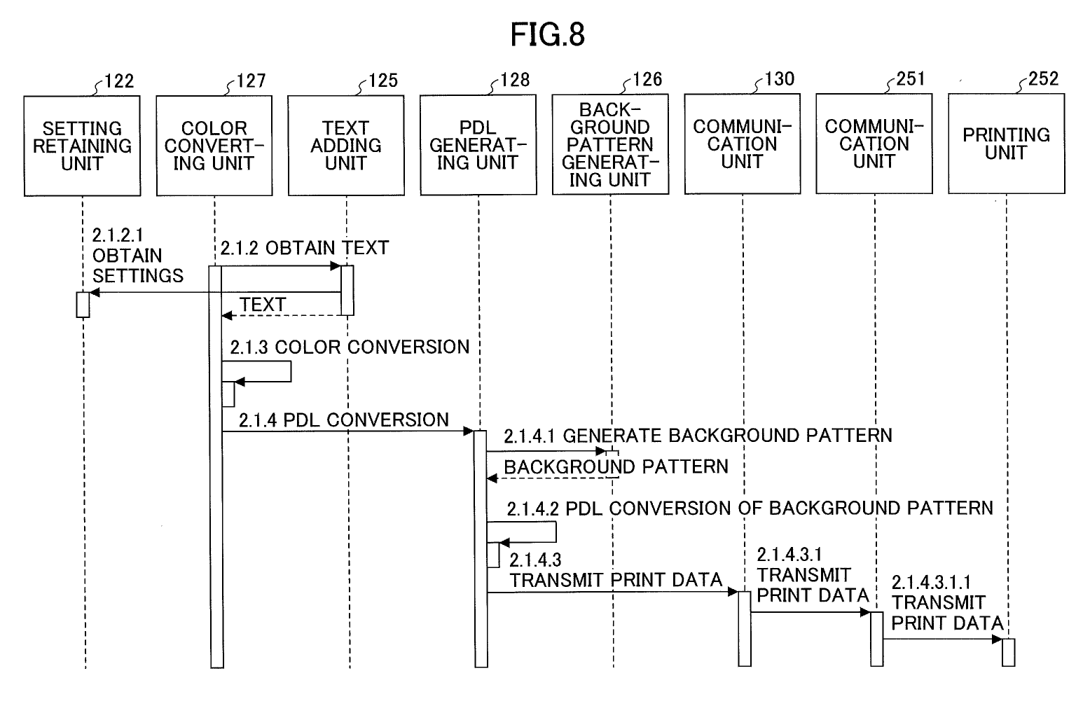

FIGS. 6 through 8 are processing sequences performed by the printing system 10 according to the first embodiment of the present invention. The processing sequence illustrated in FIG. 6 is followed by the processing sequence illustrated in FIG. 7. Also, the processing sequence illustrated in FIG. 7 is followed by the processing sequence illustrated in FIG. 8.

### <Sequence 1>

First, as illustrated in FIG. 6, from the application 100 of the PC 100, print settings related to assurance of authenticity are made on the UI screen 500 (see FIG. 5) provided by the UI unit 121 (1). The print settings are retained by the setting retaining unit 122 (1.1). In the following, “automatic” is assumed to be selected as a method for performing printing for assurance of authenticity on the UI screen 500 as illustrated in FIG. 5.

### <Sequence 2>

Next, as illustrated in FIG. 7, printing is started, and the application 110 transmits a first page of print data of a document image to the application I/F unit 123 (2). When the application I/F unit 123 receives the print data of the document image, the application I/F unit 123 instructs the color converting unit 127 to convert the print data of the document image into print data on a per-toner basis (2.1).

Upon receiving the instruction, the color converting unit 127 requests the determination unit 124 to check installed toners (2.1.1). Upon receiving the toner checking request, the determination unit 124 instructs the communication unit 130 to transmit the toner checking request to the printer 150 (2.1.1.1). Upon receiving the instruction, the communication unit 130 transmits the toner checking request to the printer 150 (2.1.1.1.1). In the printer 150, upon receiving the toner checking request, the communication unit 251 transfers the toner checking request to the detecting unit 253 (2.1.1.1.1.1).

Upon receiving the toner checking request, the detecting unit 253 detects types of toners installed in the printing unit 252 of the printer 150, and returns a detection result to the communication unit 251. The detection result is transmitted to the determination unit 124 through the communication unit 251 and the communication unit 130.

Upon receiving the detection result, based on the detection result, the determination unit 124 determines whether the invisible toner is used to perform printing for assurance of authenticity or a background pattern is used to perform printing for assurance of authenticity (2.1.1.2). To be more specific, when the detection result indicates that the invisible toner is installed in the printing unit 252 of the printer 150 (namely, when the detection result indicates that the invisible toner is installed in place of the K toner), it is determined that the invisible toner is used to perform printing for assurance of authenticity. Conversely, when the detection result indicates that the invisible toner is not installed in the printing unit 252 of the printer 150, it is determined that a background pattern is used to perform printing for assurance of authenticity. Then, the determination unit 124 returns the detection result to the color converting unit 127.

Next, as illustrated in FIG. 8, upon receiving the detection result returned from the determination unit 124, the color converting unit 127 requests the text adding unit 125 to add text for assurance of authenticity (2.1.2). Upon receiving the request, the text adding unit 125 obtains text for assurance of authenticity from the print settings retained by the setting retaining unit 122 (2.1.2.1). Next, the text adding unit 125 returns, to the color converting unit 127, the text obtained from the setting retaining unit 122.

Upon receiving the text for assurance of authenticity, the color converting unit 127 converts the print data of the document image, which has been received from the application I/F unit 123, into print data on a per-toner basis (2.1.3).

To be more specific, when the determination unit 124 determines that the invisible toner is used to perform printing for assurance of authenticity, the color converting unit 127 converts the print data of the document image, which has been received from the application I/F unit 123, into pieces of print data that use the C toner, the M toner, and the Y toner. Also, the color converting unit 127 converts print data of the text for assurance of authenticity into print data that uses the invisible toner. Note that a blackish color that is supposed to be printed with the K toner is produced by uniformly mixing the C toner, the M toner, and the Y toner.

Conversely, when the determination unit 124 determines that a background pattern is used to perform printing for assurance of authenticity, the color converting unit 127 converts the print data of the document image, which has been received from the application I/F unit 123, into pieces of print data that use the C toner, the M toner, the Y toner, and the K toner.

Note that the color converting unit 127 may perform image processing, such as color matching and dithering, on print data of a document image received from the application I/F unit 12, but does not necessarily perform image processing, such as color matching and dithering, on print data of text to be added for assurance of authenticity.

Next, the color converting unit 127 requests the PDL generating unit 128 to convert the generated print data on a per-toner basis into print data in a PDL command format (2.1.4). Upon receiving the request, the PDL generating unit 128 converts the print data on a per-toner basis, generated by the color converting unit 127, into print data in a PDL command format. At this time, in a case where the determination unit determines that a background pattern is used to perform printing for assurance of authenticity, the PDL generating unit 128 requests the background pattern generating unit 126 to generate a background pattern for assurance of authenticity (2.1.4.1). In response to this request, the background pattern generating unit 126 generates a background pattern for assurance of authenticity, and returns the background pattern to the PDL generating unit 128. Upon receiving the background pattern, the PDL generating unit 128 converts the background pattern into print data in a PDL command format (2.1.4.2).

Next, the PDL generating unit 128 instructs the communication unit 130 to transmit the print data in the PDL command format to the printer 150 (2.1.4.3). Upon receiving the instruction, the communication unit 130 transmits the print data in the PDL command format to the printer 150 (2.1.4.3.1). In the printer 150, when the communication unit 251 receives the print data, the communication unit 251 transfers the print data to the printing unit 252 (2.1.4.3.1.1). Upon receiving the print data, the printing unit 252 performs printing based on the received print data.

The above sequences allow the printer 150 to print the first page of the document image transmitted from the application 110 on a print medium.

To be more specific, when the invisible toner is installed in the printing unit 252 of the printer 150, the first page of the document image is printed on the print medium by using the C toner, the M toner, and the Y toner. Further, the text for assurance of authenticity is printed on the print medium by using the invisible toner.

Conversely, when the invisible toner is not installed in the printing unit 252 of the printer 150, the first page of the document image is printed on the print medium by using the C toner, the M toner, the Y toner, and the K toner. Further, the background pattern of text for assurance of authenticity is printed on the print medium by using the K toner.

In a case where the text for assurance of authenticity is printed by using the invisible toner, it is preferable for the PC 100 to transmit the print data of the document image to the printer 150 first, and to subsequently transmit the print data of the text to the printer 150. As a result, the text can be printed by using the invisible toner after the document image is printed, in such a manner that the text is superimposed on the document image. Accordingly, an effect of printing the text by using the invisible toner can be enhanced.

In a case where the background pattern for assurance of authenticity is printed by using the K toner in such a manner that the background pattern becomes noticeable, the PC 100 may transmit the print data of the document image to the printer 150 first, and may subsequently transmit the print data of the background pattern to the printer 150. Conversely, in order to print the background pattern in an unnoticeable manner, the print data of the background pattern may be transmitted to the printer 150 first, and subsequently, the print data of the document image may be transmitted to the printer 150.

### (Determination Logic of Authenticity Assurance Function)

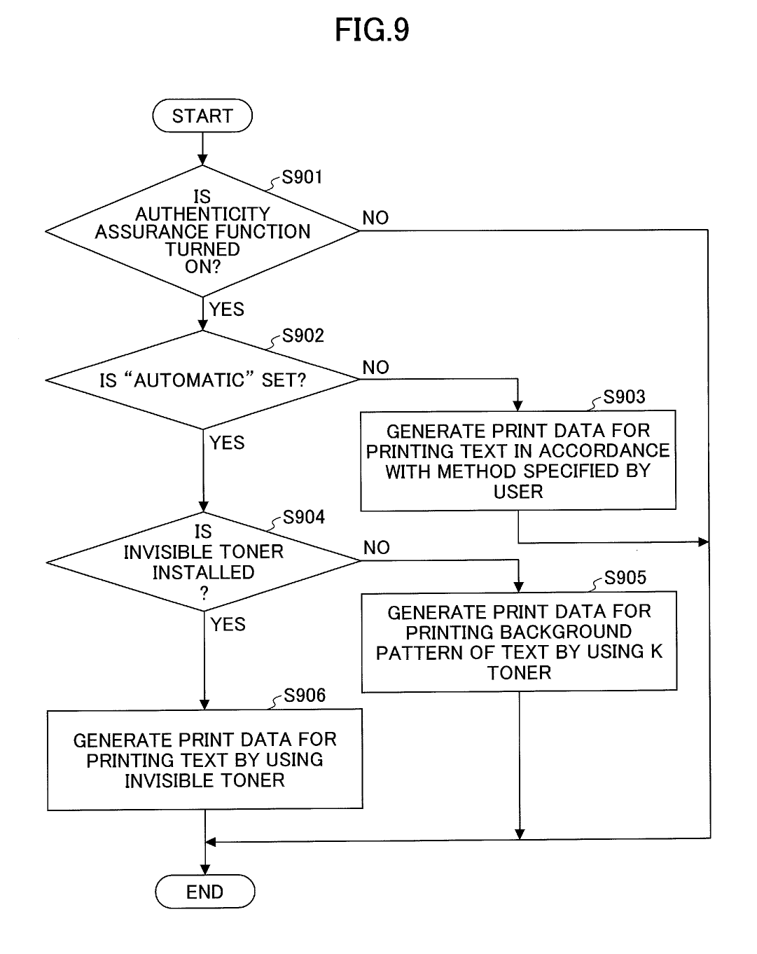

FIG. 9 is a flowchart illustrating determination logic of an authenticity assurance function of the PC 100 according to the first embodiment of the present invention.

First, the PC 100 determines whether the authenticity assurance function is turned on in print settings retained by the setting retaining unit 122 (step S901). In step S901, when it is determined that the authenticity assurance function is not turned on (no in step S901), the PC 100 ends the process illustrated in FIG. 9.

Conversely, in step S901, when it is determined that the authenticity assurance function is turned on (yes in step S901), the PC 100 determines whether the authenticity assurance function is set to “automatic” in the print settings retained by the setting retaining unit 122 (step S902).

In step S902, when it is determined that the authenticity assurance function is not set to “automatic” (no in step S902), the PC 100 generates print data for printing text on a print medium in accordance with a method (either a method for using the invisible toner or a method for using a background pattern with the K toner) specified by the user in the print settings retained by the setting retaining unit 122 (step S903). Then, the PC 100 ends the process illustrated in FIG. 9.

Conversely, in step S902, when it is determined that the authenticity assurance function is set to “automatic” (yes in step S902), the PC 100 determines whether the invisible toner is installed in the printing unit 252 of the printer 150 (step S904).

In step S904, when it is determined that the invisible toner is installed (yes in step S904), the PC 100 generates print data for printing text on a print medium by using the invisible toner (step S906). Then, the PC 100 ends the process illustrated in FIG. 9.

Conversely, in step S904, when it is determined that the invisible toner is not installed (no in step S904), the PC 100 generates print data for printing a background pattern of text on a print medium by using the K toner (step S905). Then, the PC 100 ends the process illustrated in FIG. 9.

### Second Embodiment

Next, a second embodiment of the present invention will be described. In the following, differences from the first embodiment will be described.

### (Functional Configuration of Printing System 10A)

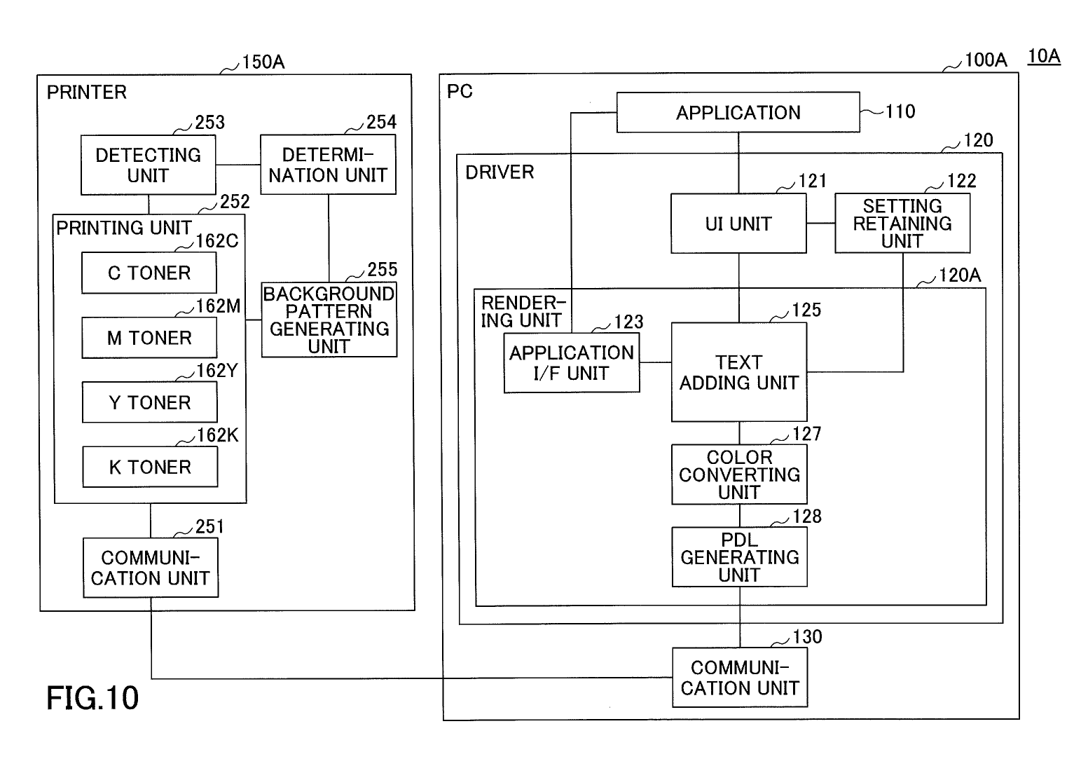

FIG. 10 is a diagram illustrating a functional configuration of a printing system 10A according to the second embodiment of the present invention. As illustrated in FIG. 10, the printing system 10A according to the second embodiment differs from the printing system 10 according to the first embodiment in that the printing system 10A includes a PC 100A and a printer 150A instead of the PC 100 and the printer 150.

The PC 100A differs from the PC 100 in that the PC 100A does not include the determination unit 124 and the background pattern generating unit 126. The printer 150A differs from the printer 150 in that the printer 150A includes a determination unit 254 and a background pattern generating unit 255.

The determination unit 254 determines whether the printer 150A can perform printing with an invisible toner, based on types of toners detected by the detecting unit 253 of the printer 150A. For example, when the detecting unit 253 detects that the invisible toner is installed in the printer 150A in place of any one of the C toner, the M toner, the Y toner, and the K toner, the determination unit 124 determines that printing with the invisible toner is possible. Conversely, when the detecting unit 253 detects that the invisible toner is not installed in the printer 150A in place of any one of the C toner, the M toner, the Y toner, and the K toner, the determination unit 124 determines that printing with the invisible toner is not possible.

When a setting that causes the printer 150A to perform printing with the invisible toner for assurance of authenticity is made in print settings retained by the setting retaining unit 122 of the PC 100A (for example, in a case where “invisible toner” is selected on the UI screen 500 illustrated in FIG. 5), it is determined that printing with the invisible toner is possible. Conversely, when a setting that causes the printer 150A to perform printing with the invisible toner for assurance of authenticity is not made in print settings retained by the setting retaining unit 122 of the PC 100A (for example, when “background pattern” is selected on the UI screen 500 illustrated in FIG. 5), it is determined that printing with the invisible toner is not possible.

When the determination unit 254 determines that printing with the invisible toner is not possible, the background pattern generating unit 255 generates a background pattern of text added by the text adding unit 125 of the PC 100A.

### (Processing Sequences Performed by Printing System 10A)

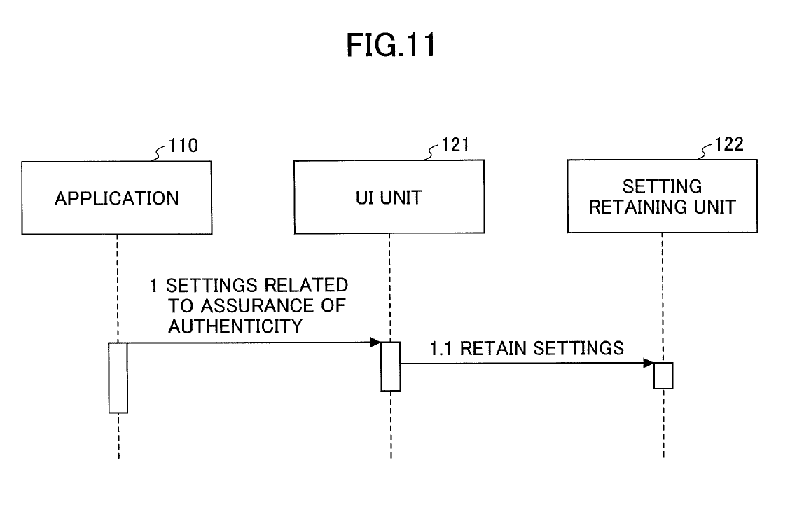

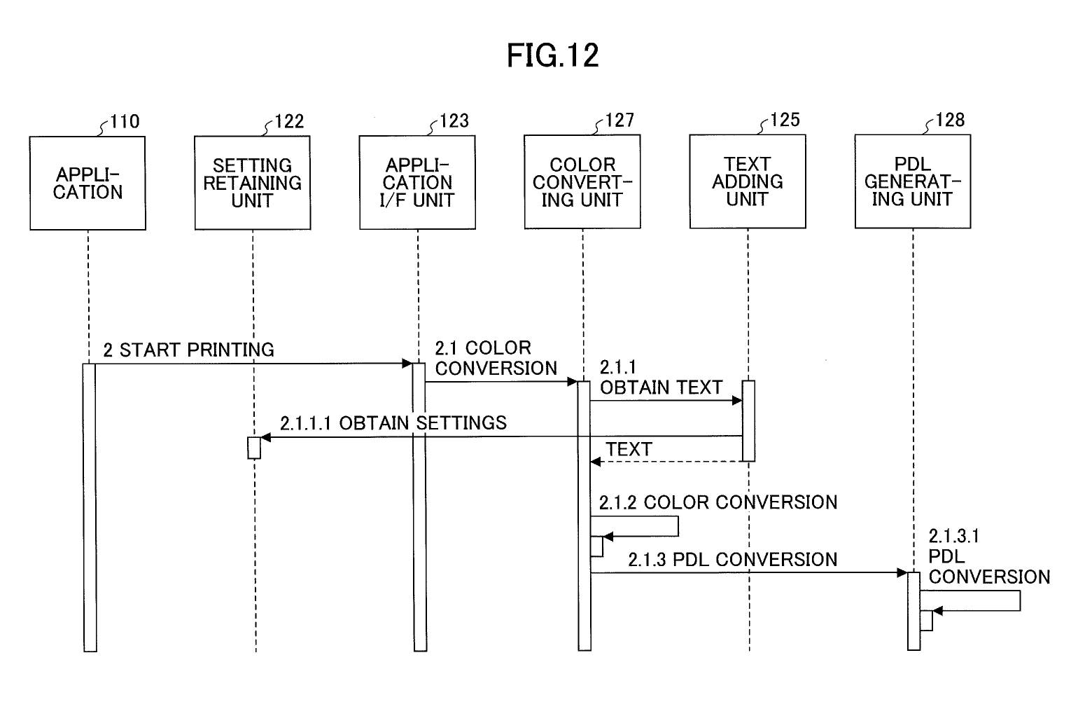

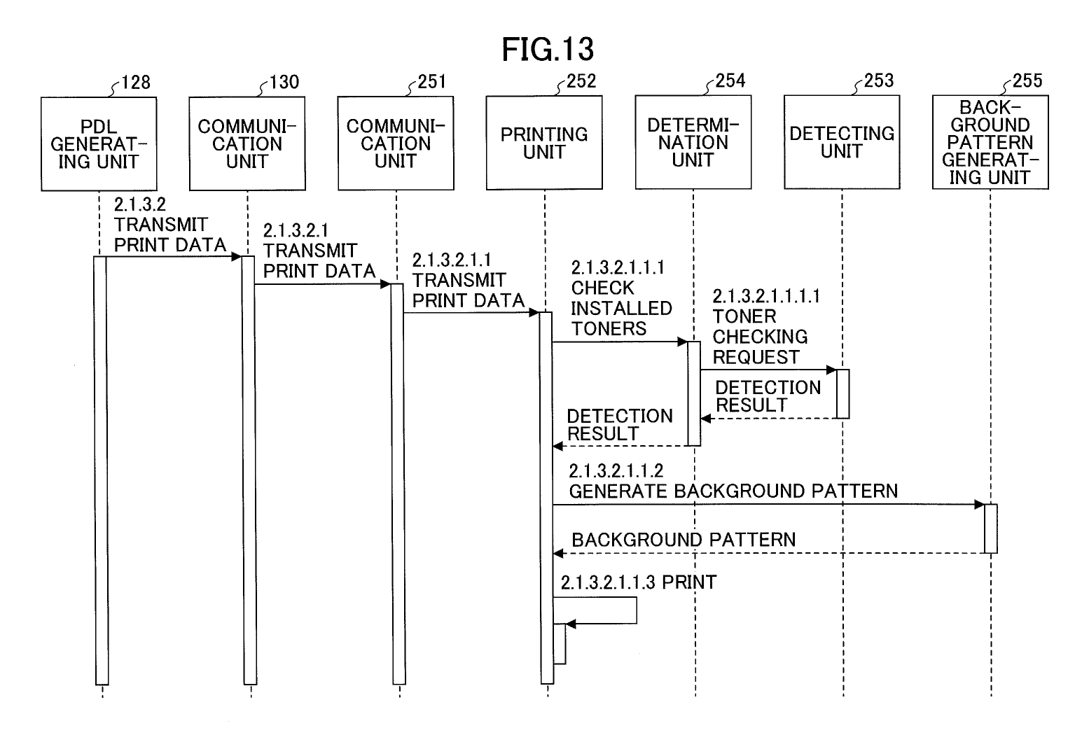

FIGS. 11 through 13 are processing sequences performed by the printing system 10A according to the second embodiment of the present invention. The processing sequence illustrated in FIG. 11 is followed by the processing sequence illustrated in FIG. 12. Also, the processing sequence illustrated in FIG. 12 is followed by the processing sequence illustrated in FIG. 13.

### <Sequence 1>

First, as illustrated in FIG. 11, from the application 110 of the PC 100A, print settings related to assurance of authenticity are made on the UI screen 500 (see FIG. 5) provided by the UI unit 121 (1). The print settings are retained by the setting retaining unit 122 (1.1). In the following, “automatic” is assumed to be selected as a method for performing printing for assurance of authenticity on the UI screen 500 as illustrated in FIG. 5.

### <Sequence 2>

Next, as illustrated in FIG. 12, printing is started, and the application 110 transmits a first page of print data of a document image to the application I/F unit 123 (2). When the application I/F unit 123 receives the print data of the document image, the application I/F unit 123 instructs the color converting unit 127 to convert the print data of the document image into print data on a per-toner basis (2.1).

Upon receiving the instruction, the color converting unit 127 requests the text adding unit 125 to add text for assurance of authenticity (2.1.1). Upon receiving the request, the text adding unit 125 obtains text for assurance of authenticity from the print settings retained by the setting retaining unit 122 (2.1.1.1). Next, the text adding unit 125 returns, to the color converting unit 127, the text obtained from the setting retaining unit 122.

Upon receiving the text for assurance of authenticity, the color converting unit 127 converts the print data of the document image, which has been received from the application I/F unit 123, into print data on a per-toner basis (2.1.2).

To be more specific, the color converting unit 127 converts the print data of the document image, which has been received from the application I/F unit 123, into pieces of print data that use the C toner, the M toner, and the Y toner.

Next, the color converting unit 127 requests the PDL generating unit 128 to convert the generated print data on a per-toner basis into print data in a PDL command format (2.1.3). Upon receiving the request, the PDL generating unit 128 converts the print data on a per-toner basis, generated by the color converting unit 127, into print data in a PDL command format (2.1.3.1).

Next, as illustrated in FIG. 13, the PDL generating unit 128 instructs the communication unit 130 to transmit the print data in the PDL command format to the printer 150A, together with the text obtained by the text adding unit 125 (2.1.3.2). Upon receiving the instruction, the communication unit 130 transmits the print data in the PDL command format to the printer 150A, together with the text obtained by the text adding unit 125 (2.1.3.2.1). In the printer 150A, when the communication unit 251 receives the print data, the communication unit 251 transfers the print data to the printing unit 252 (2.1.3.2.1.1).

Upon receiving the print data, the printing unit 252 requests the determination unit 254 to check installed toners (2.1.3.2.1.1.1). Upon receiving the toner checking request, the determination unit 254 transfers the toner checking request to the detecting unit 253 (2.1.3.2.1.1.1.1).

Upon receiving the toner checking request, the detecting unit 253 detects types of toners installed in the printing unit 252 of the printer 150A, and returns a detection result to the determination unit 254.

Upon receiving the detection result, based on the detection result, the determination unit 254 determines whether the invisible toner is used to perform printing for assurance of authenticity or a background pattern is used to perform printing for assurance of authenticity. To be more specific, when the detection result indicates that the invisible toner is installed in the printing unit 252 of the printer 150A (namely, when the detection result indicates that the invisible toner is installed in place of the K toner), it is determined that the invisible toner is used to perform printing for assurance of authenticity. Conversely, when the detection result indicates that the invisible toner is not installed in the printing unit 252 of the printer 150A, it is determined that a background pattern is used to perform printing for assurance of authenticity. Then, the determination unit 254 returns the detection result to the printing unit 252.

When the determination unit 254 determines that a background pattern is used to perform printing for assurance of authenticity, the printing unit 252 requests the background pattern generating unit 255 to generate a background pattern for assurance of authenticity (2.1.3.2.1.1.2).

In response to the request, the background pattern generating unit 255 generates a background pattern for assurance of authenticity, and returns the background pattern to the printing unit 252. Upon receiving the background pattern, the printing unit 252 prints the first page of the document image, which has been transmitted from the application 110, on a print medium.

To be more specific, when the invisible toner is installed in the printing unit 252 of the printer 150A, the printing unit 252 uses the C toner, the M toner, and the Y toner to print the first page of the document image on the print medium. Further, the printing unit 252 uses the invisible toner to print the text for assurance of authenticity on the print medium (2.1.3.2.1.1.3).

Conversely, when the invisible toner is not installed in the printing unit 252 of the printer 150A, the printing unit 252 uses the C toner, the M toner, and the Y toner to print the first page of the document image on the print medium. Further, the printing unit 252 uses the K toner to print the background pattern of text for assurance of authenticity on the print medium (2.1.3.2.1.1.3).

### (Determination Logic of Authenticity Assurance Function)

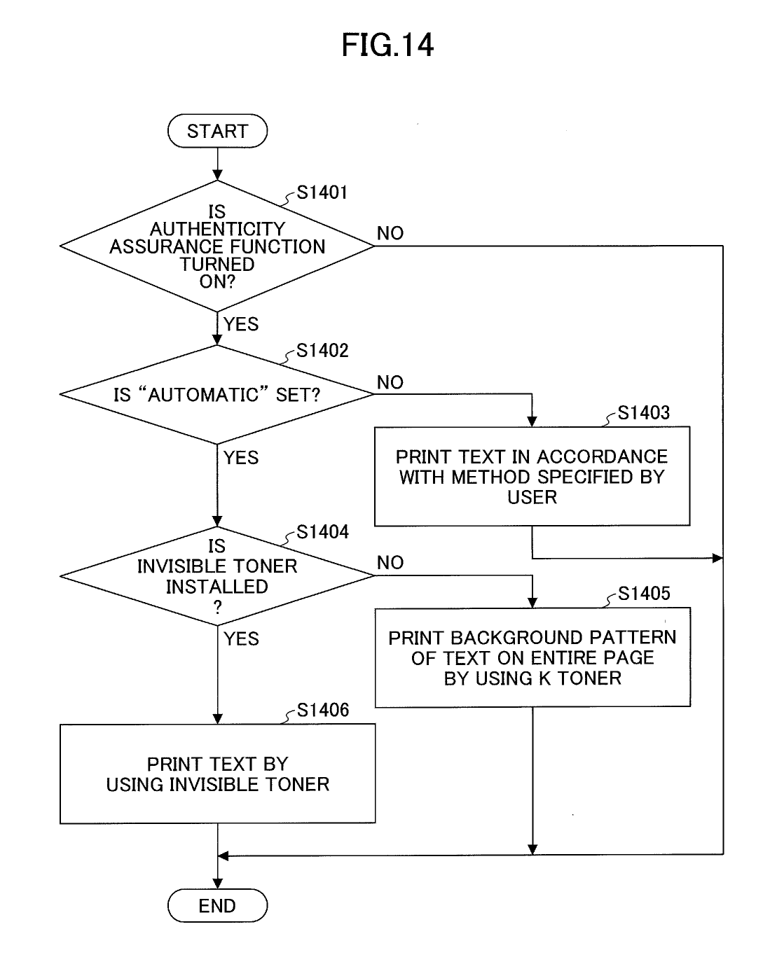

FIG. 14 is a flowchart illustrating determination logic of an authenticity assurance function of the printer 150A according to the second embodiment of the present invention.

First, the printer 150A determines whether the authenticity assurance function is turned on in print settings retained by the setting retaining unit 122 of the PC 100A (step S1401). In step S1401, when it is determined that the authenticity assurance function is not turned on (no in step S1401), the PC 100 ends the process illustrated in FIG. 14.

Conversely, in step S1401, when it is determined that the authenticity assurance function is turned on (yes in step S1401), the printer 150A determines whether the authenticity assurance function is set to “automatic” in the print settings retained by the setting retaining unit 122 (step S1402).

In step S1402, when it is determined that the authenticity assurance function is not set to “automatic” (no in step S1402), the printer 150A prints text on a print medium in accordance with a method (either a method for using the invisible toner or a method for using a background pattern with the K toner) specified by the user in the print settings retained by the setting retaining unit 122 (step S1403). Then, the printer 150A ends the process illustrated in FIG. 14.

Conversely, in step S1402, when it is determined that the authenticity assurance function is set to “automatic” (yes in step S1402), the printer 150A determines whether the invisible toner is installed in the printing unit 252 of the printer 150A (step S1404).

In step S1404, when it is determined that the invisible toner is installed (yes in step S1404), the printer 150A prints text for assurance of authenticity on a print medium by using the invisible toner (step S1406). Then, the PC 100 ends the process illustrated in FIG. 14.

Conversely, in step S1404, when it is determined that the invisible toner is not installed (no in step S1404), the printer 150A prints a background pattern of text on a print medium by using the K toner (step S1405). Then, the printer 150A ends the process illustrated in FIG. 14.

### (Example of Print Setting Information Transmitted to Printer 150A)

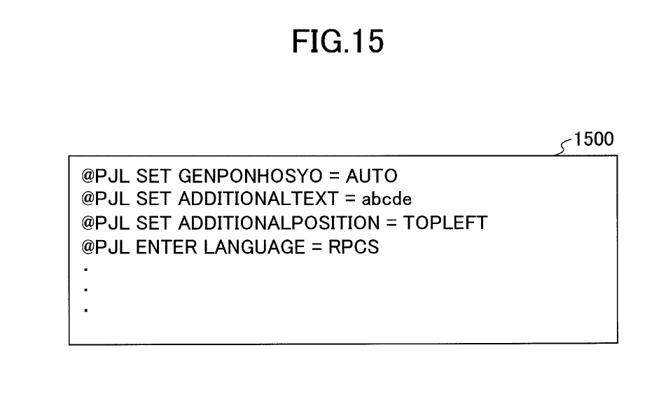

FIG. 15 is a diagram illustrating an example of print setting information transmitted to the printer 150A in the printing system 10A according to the second embodiment.

Print setting information 1500 illustrated in FIG. 15 is transmitted from the PC 100A to the printer 150A in the printing system 10A. The print setting information 1500 is setting information that has been obtained from print settings retained by the setting retaining unit 122 of the printing system 10A and that has been converted into a printer job language (PJL) format.

For example, “@PJL SET GENPONHOSYO=AUTO” in the first line of the print setting information 1500 means that the authenticity assurance function is set to “automatic” in the print settings.

Also, for example, “@PJL SET ADDITIONALTEXT=abcde” in the second line of the print setting information 1500 means that “abcde” is set as text in the print settings.

Also, for example, “@PJL SET ADDITIONALPOSITION=TOPLEFT” in the third line of the print setting information 1500 means that “top left” is set as a printing position of the text in the print settings.

Also, for example, “@PJL ENTER LANGUAGE=RPCS” in the fourth line of the print setting information 1500 means that “Refined Printing Command Stream (RPCS)” is used as a printer driver used by the PC 100A.

For example, the print setting information 1500 is added to print data (namely, print data of a document image) in a page description language (PDL) command format, and is transmitted from the PC 100A to the printer 150A. Accordingly, the printer 150A can obtain print settings related to assurance of authenticity, and based on the obtained print settings, the printer 150A can perform printing for assurance of authenticity by using the invisible toner or a background pattern.

According to the above-described embodiments, when printing with the invisible toner is determined to be possible in the printers 150 and 150A, the printing systems 10 and 10A cause the printers 150 and 150A to use the invisible toner to perform printing for assurance of authenticity. Conversely, when printing with the invisible toner is determined not to be possible in the printers 150 and 150A, the printing systems 10 and 10A cause the printers 150 and 150A to use a toner (for example, the K toner) other than the invisible toner to perform printing for assurance of authenticity. In other words, according to the above-described embodiments, the printing systems 10 and 10A can cause the printers 150 and 150A to perform printing for assurance of authenticity, regardless of whether printing with the invisible toner is possible. Therefore, according to the printing systems 10 and 10A of the above-described embodiments, printing for assurance of authenticity can be performed, regardless of whether the image forming apparatus can use the invisible toner.

In particular, according to the above-described embodiments, when printing with the invisible toner is determined not to be possible in the printers 150 and 150A, the printing systems 10 and 10A can cause the printers 150 and 150A to use a toner other than the invisible toner to print a background pattern for assurance of authenticity. Accordingly, for example, if an original print medium having a background pattern for assurance of authenticity is copied, the background pattern becomes apparent on a destination print medium, allowing the user to recognize that the destination print medium is a secondary copy. Therefore, the authenticity of the original print medium can be assured.

According to at least one embodiment of the present invention, printing for assurance of authenticity can be performed regardless of whether the image forming apparatus can use the invisible toner.

In the above-described embodiments, in the printer 150 having the Y toner 162Y, the C toner 162C, the M toner 162M, and the K toner 162K, the invisible toner is installed in place of the K toner 162K; however, the present invention is not limited thereto. For example, in the printer 150 having the Y toner 162Y, the C toner 162C, the M toner 162M, and the K toner 162K, the invisible toner may be installed in addition to these four toners.

In the above-described embodiments, the invisible toner or the background pattern is used to print text for assurance of authenticity; however, the present invention is not limited thereto. For example, the invisible toner or the background pattern is used to print a figure for assurance of authenticity.

Also, in the above-described embodiments, when the invisible toner is installed in the printers 150 and 150A, it is determined that printing with the invisible toner is possible; however, the present invention is not limited thereto. For example, even if the invisible toner is installed in the printers 150 and 150A, it may be determined that printing with the invisible toner is not possible if the remaining amount of the invisible toner is less than or equal to a predetermined amount.

Further, when a toner other than the invisible toner is used to perform printing for assurance of authenticity, a method for performing printing for assurance of authenticity is not limited to a method for printing a background pattern. Other methods (such as a method for printing, on a corner of a page, characters that are too small to be visible when copied) may be used to perform printing for assurance of authenticity.

Although the embodiments of the present invention have been specifically described above, the present invention is not limited to the above-described embodiments. Various modifications and variations may be made without departing from the scope of the present invention.

What is claimed is

1. A printing system comprising:
a memory; and
a processor coupled to the memory and configured to
determine whether printing with an invisible toner is possible in an image forming apparatus, and
generate, when the printing with the invisible toner is determined to be possible, print data for causing the image forming apparatus to use the invisible toner to perform printing for assurance of authenticity, and generate, when the printing with the invisible toner is determined not to be possible, print data for causing the image forming apparatus to use a toner other than the invisible toner to perform printing for assurance of authenticity.

2. The printing system according to claim 1, wherein the processor is configured to generate, when the printing with the invisible toner is determined not to be possible, print data for causing the image forming apparatus to use the toner other than the invisible toner to print a background pattern for assurance of authenticity.

3. The printing system according to claim 1, wherein the processor is configured to determine that the printing with the invisible toner is possible when the invisible toner is installed in the image forming apparatus in place of any one of a cyan toner, a magenta toner, a yellow toner, and a black toner.

4. The printing system according to claim 1, wherein the processor is configured to determine that the printing with the invisible toner is possible when the invisible toner is installed in the image forming apparatus in addition to a cyan toner, a magenta toner, a yellow toner, and a black toner.

5. The printing system according to claim 1, wherein the processor is further configured to detect types of toners installed in the image forming apparatus, and is configured to determine that the printing with the invisible toner is possible when the invisible toner is included in the types of toners detected by the detector.

6. The printing system according to claim 1, wherein the processor is further configured to provide a user interface that allows a user to make print settings related to the printing for assurance of authenticity, and is configured to determine that the printing with the invisible toner is possible when a setting that causes the image forming apparatus to use the invisible toner to perform the printing for assurance of authenticity is made in the print settings.

7. An image forming apparatus including a printing mechanism, the image forming apparatus comprising:
a memory; and
a processor coupled to the memory and configured to
determine whether printing with an invisible toner is possible in the printing mechanism, and
generate, when the printing with the invisible toner is determined to be possible, print data for causing the printing mechanism to use the invisible toner to perform printing for assurance of authenticity, and configured to generate, when the printing with the invisible toner is determined not to be possible, print data for causing the printing mechanism to use a toner other than the invisible toner to perform printing for assurance of authenticity.

8. The image forming apparatus according to claim 7, wherein the processor is configured to generate, when the printing with the invisible toner is determined not to be possible, print data for causing the printing mechanism to use the toner other than the invisible toner to print a background pattern for assurance of authenticity.

9. The image forming apparatus according to claim 7, wherein the processor is configured to determine that the printing with the invisible toner is possible when the invisible toner is installed in the printing mechanism in place of any one of a cyan toner, a magenta toner, a yellow toner, and a black toner.

10. The image forming apparatus according to claim 7, wherein the processor is configured to determine that the printing with the invisible toner is possible when the invisible toner is installed in the printing mechanism in addition to a cyan toner, a magenta toner, a yellow toner, and a black toner.

11. The image forming apparatus according to claim 7, wherein the processor is further configured to detect types of toners installed in the printing mechanism, and is configured to determine that the printing with the invisible toner is possible when the invisible toner is included in the types of toners detected by the detector.

12. A non-transitory recording medium storing a program for causing a computer to execute a process comprising:
determining whether printing with an invisible toner is possible in an image forming apparatus; and
generating, when the printing with the invisible toner is determined to be possible, print data for causing the image forming apparatus to use the invisible toner to perform printing for assurance of authenticity, and generating, when the printing with the invisible toner is determined not to be possible, print data for causing the image forming apparatus to use a toner other than the invisible toner to perform printing for assurance of authenticity.

13. The non-transitory recording medium according to claim 12, wherein when the printing with the invisible toner is determined not to be possible, print data for causing the image forming apparatus to use the toner other than the invisible toner to print a background pattern for assurance of authenticity is generated.

14. The non-transitory recording medium according to claim 12, wherein the printing with the invisible toner is determined to be possible when the invisible toner is installed in the image forming apparatus in place of any one of a cyan toner, a magenta toner, a yellow toner, and a black toner.

15. The non-transitory recording medium according to claim 12, wherein the printing with the invisible toner is determined to be possible when the invisible toner is installed in the image forming apparatus in addition to a cyan toner, a magenta toner, a yellow toner, and a black toner.

16. The non-transitory recording medium according to claim 12, wherein the process further includes detecting types of toners installed in the image forming apparatus, and the printing with the invisible toner is determined to be possible when the invisible toner is included in the detected types of toners.

17. The non-transitory recording medium according to claim 12, wherein the process further includes providing a user interface that allows a user to make print settings related to the printing for assurance of authenticity, and the printing with the invisible toner is determined to be possible when a setting that causes the image forming apparatus to use the invisible toner to perform the printing for assurance of authenticity is made in the print settings.
